(19) United States
(12) Patent Application Publication
(10) Pub. No.: US 2020/0097732 A1
(43) Pub. Date: Mar. 26, 2020

(54) Markerless Human Movement Tracking in Virtual Simulation

(71) Applicant: Cubic Corporation, San Diego, CA (US)

(72) Inventors: Keith Doolittle, Orlando, FL (US); Lifan Hua, Orlando, FL (US)

(73) Assignee: Cubic Corporation, San Diego, CA (US)

(21) Appl. No.: 16/576,977

(22) Filed: Sep. 20, 2019

Related U.S. Application Data
(60) Provisional application No. 62/734,732, filed on Sep. 21, 2018.

(51) Int. Cl. G06K 9/00; G06T 7/73; G06T 7/80; H04N 13/117

(52) U.S. Cl. CPC G06K 9/00744; G06K 9/00342; H04N 13/117; G06T 7/85; G06T 7/75

(57) ABSTRACT

A simulation system is disclosed in which images are captured of one or more subjects within a simulation volume, the images are analyzed to determine 2D keypoints for each of subject (where the 2D keypoints for a subject collectively represent the body position and/or posture of the respective subject), and corresponding 3D keypoints (and thus a complete 3D skeletal pose of each subject) of each subject are created from the 2D keypoints. This can be done for multiple frames, and tracking can be performed by matching 3D keypoints of a subject from a first frame with corresponding 3D keypoints from a successive frame.

### CROSS-REFERENCES TO RELATED APPLICATIONS

This application claims the benefit of priority under 35 USC § 119(e) to U.S. Provisional Patent Application No. 62/734,732, filed Sep. 21, 2018, entitled “Markerless Human Movement Tracking In Virtual Simulation,” the entire contents of which are incorporated by reference herein for all purposes.

### BACKGROUND

Tracking human movement of one or more subjects (e.g., trainees in a simulated training environment) by camera has been utilized in a variety of applications, including gesture detection, automated crowd determination, and the like. For applications in which a subject may be able to move around in a larger 3D simulation space, the subject will often needs to wear motion tracking attachment or devices to capture body position and posture more accurately. That is, traditional solutions for tracking subject movement in a simulation space typically require the subject to wear passive or active infrared (IR) markers on their person to facilitate capturing joint positions with an array of IR cameras located on a truss, surrounding the subject. These traditional solutions usually require a large number of expensive cameras to capture these markers from all different angles.

### BRIEF SUMMARY

Embodiments disclosed herein address these and other concerns by providing for a simulation system in which images are captured of one or more subjects within a simulation volume, the images are analyzed to determine 2D keypoints for each of subject (where the 2D keypoints for a subject collectively represent the body position and/or posture of the respective subject), and corresponding 3D keypoints of each subject are created from the 2D keypoints. This can be done for multiple frames, and tracking can be performed by matching 3D keypoints of a subject from a first frame with corresponding 3D keypoints from a successive frame. This can enable the tracking of the body position and/or posture of the subject(s) without requiring the subject(s) to don any tracking markers. Moreover, embodiments can utilize low-cost Common Off The Shelf (COTS) video cameras (e.g., webcams) that can significantly reduce the cost of the overall simulation system.

An example of a system for tracking human movement, according to this description, comprises a plurality of cameras, wherein each camera is configured to capture, at a first time, a respective image of one or more human subjects in a simulation volume, resulting in a respective first plurality of images of the one or more human subjects in the simulation volume taken at the first time. The system further comprises one or more computer systems communicatively coupled with the plurality of cameras and configured to determine, for each image of the first plurality of images, a respective plurality of keypoints for each of the one or more human subjects, wherein determining the respective plurality of keypoints comprises using image recognition on the respective image to identify the keypoints for each of the one or more human subjects, independent of what the one or more human subjects are wearing. The one or more computer systems are further configured to compare, for each image of the first plurality of images, the respective plurality of keypoints for each of the one or more human subjects with a respective plurality of keypoints for each of the one or more human subjects of one or more other images of the first plurality of images, and determine a first 3D representation of each of the one or more human subjects, based on the comparison.

An example method of tracking human movement, according to this description, comprises obtaining, at a first time, from each camera of a plurality of cameras, a respective image of one or more human subjects in a simulation volume, resulting in a respective first plurality of images of the one or more human subjects in the simulation volume taken at the first time, and determining, for each image of the first plurality of images, a respective plurality of keypoints for each of the one or more human subjects, wherein determining the respective plurality of keypoints comprises using image recognition on the respective image to identify the keypoints for each of the one or more human subjects, independent of what the one or more human subjects are wearing. The method further includes comparing, for each image of the first plurality of images, the respective plurality of keypoints for each of the one or more human subjects with a respective plurality of keypoints for each of the one or more human subjects of one or more other images of the first plurality of images, and determining a first 3D representation of each of the one or more human subjects, based on the comparison.

An example non-transitory computer-readable medium, according to this description, has instructions stored therewith for tracking human movement. The instructions, when executed by one or more processing units, cause the one or more processing units to obtain, at a first time, from each camera of a plurality of cameras, a respective image of one or more human subjects in a simulation volume, resulting in a respective first plurality of images of the one or more human subjects in the simulation volume taken at the first time. The instructions, when executed by the one or more processing units, further the one or more processing units to determine, for each image of the first plurality of images, a respective plurality of keypoints for each of the one or more human subjects, wherein determining the respective plurality of keypoints comprises using image recognition on the respective image to identify the keypoints for each of the one or more human subjects, independent of what the one or more human subjects are wearing. The instructions, when executed by the one or more processing units, further the one or more processing units to compare, for each image of the first plurality of images, the respective plurality of keypoints for each of the one or more human subjects with a respective plurality of keypoints for each of the one or more human subjects of one or more other images of the first plurality of images, and determine a first 3D representation of each of the one or more human subjects, based on the comparison.

### BRIEF DESCRIPTION OF THE DRAWINGS

For a more complete understanding of this invention, reference is now made to the following detailed description of the embodiments as illustrated in the accompanying drawings, in which like reference designations represent like features throughout the several views and wherein:

FIG. 1 is a simplified diagram of a simulation system, according to an embodiment;

FIG. 2 is a flow diagram, illustrating a method executed at a client to provide keypoint information to a server, according to an embodiment;

FIG. 3 is a flow diagram illustrating a method executed at a server, according to an embodiment;

FIG. 4 is a flow diagram of an embodiment of a method that may be used by a solver algorithm to combine 2D keypoints extracted from video data of subjects in a simulation volume into 3D keypoints for each of the subjects;

FIG. 5 is a block diagram of a computer system, according to an embodiment; and

FIG. 6 is a block diagram of a method for tracking human movement, according to an embodiment.

In the appended figures, similar components and/or features may have the same reference label. Further, various components of the same type may be distinguished by following the reference label by a dash and a second label that distinguishes among the similar components. If only the first reference label is used in the specification, the description is applicable to any or all of the similar components having the same first reference label irrespective of the second reference label.

### DETAILED DESCRIPTION

The ensuing description provides embodiments only, and is not intended to limit the scope, applicability or configuration of the disclosure. Rather, the ensuing description of the embodiments will provide those skilled in the art with an enabling description for implementing an embodiment. It is understood that various changes may be made in the function and arrangement of elements without departing from the scope.

Embodiments of the invention(s) described herein are generally related to a system for tracking human movement, including position and posture, using video cameras without wearing any markers. Although embodiments described herein are utilized for creating a simulation environment (e.g., for military, paramilitary, law enforcement, commercial, and/or other types of training), alternative embodiments may be utilized in other types of applications. Briefly put, embodiments can generally include the following features. Embodiments may comprise a plurality of video cameras, one or more computer systems (such as Personal Computers (PCs) or computer servers), communication links between video cameras and computer systems, and computer software for image processing and movement calculations. The plurality of video cameras capture images of one or more subjects in a room or other simulation volume, and provide the images to the computer systems. The computer systems can then estimate joint positions and/or other “keypoints” of subjects in two dimensions (2D) from each camera using image-recognition algorithms, such as machine learning (ML) algorithms trained to locate human joint positions. These 2D results can be combined, and a full skeleton of the subject is recovered in three dimensions (3D) using, for example, stereoscopic computer vision algorithms. This skeleton accurately represents both the physical position and pose of the subject in the simulation space, and can be mapped to virtual avatars in the simulation in real-time. The captured body movements and actions can be mapped to the corresponding body movement and actions of associated virtual subject avatars in real time. Subjects do not need to wear any motion tracking markers or motion capture suits. As such, embodiments can improve training realism without using any additional equipment for motion capture. Additional description certain embodiments is provided herein below, with reference to the appended figures.

As used herein, the term “keypoints” can include any of a variety of points corresponding to locations of a subject's body. Although embodiments described herein indicate keypoints as corresponding to joints, alternative embodiments may not be so limited, and may include other points on/in the subject's body (e.g., sternum, head, etc.) that are not considered to be joints. As discussed in further detail below, keypoints provided by computer clients (or simply “clients”) to a computer server (or simply “server”) may comprise locations on an image (e.g., XY coordinates) at which corresponding body parts (e.g., joints) are located. Keypoints comprising locations on a 2D image corresponding to points in/on a subject's body may be connected to form a 2D “skeleton” of the subject.

As referred to herein, a “skeleton” corresponding to a subject may not necessarily represent a biological skeleton, but may instead comprise a stick figure-like representation of a subject, generally representing the location (and, in some embodiments, orientation) of the subject's appendages. As noted above, a 2D skeleton of a subject may be formed from keypoints on one or more images of the subject, and a 3D skeleton may be formed in the 3D space from multiple 2D skeletons of the subject from different images, which may be taken at different angles. As discussed in further detail below, a 3D skeleton may comprise locations in a volume (e.g., XYZ coordinates within the simulation space) at which body parts (e.g., joints and other keypoints) are located.

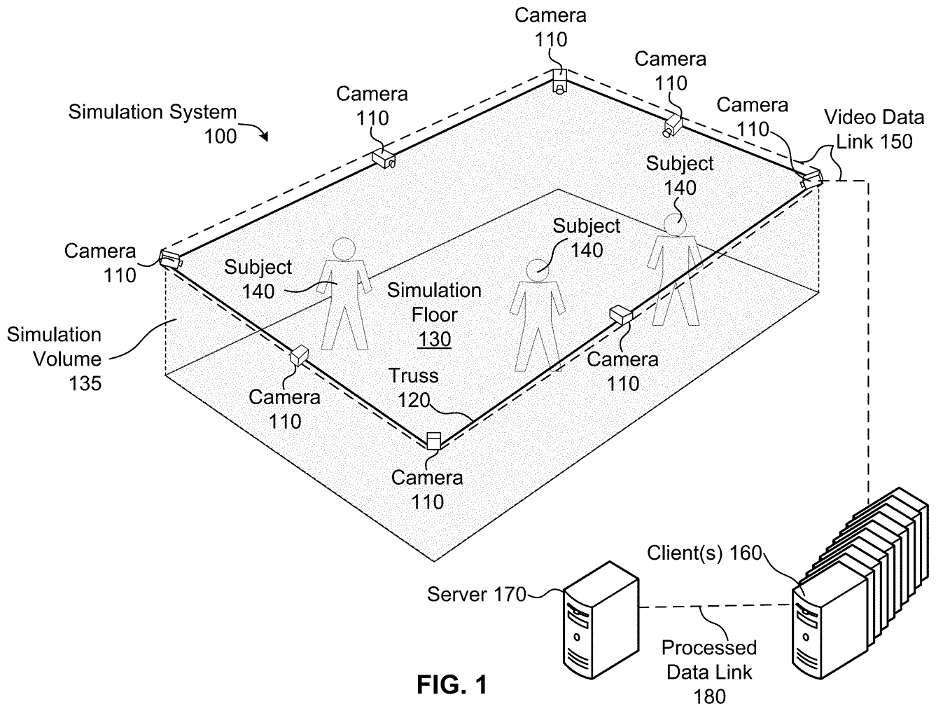

FIG. 1 is a simplified diagram of a simulation system 100, according to an embodiment. Here, the simulation comprises a plurality of cameras 110 coupled with a truss 120 that is suspended above a simulation floor 130, creating a simulation volume 135 in which one or more subjects 140 may be located during a simulation exercise. Video data from the cameras 110 is conveyed via a video data link 150 to one or more clients 160 which process the video data as described in further detail below. Processed data is then sent to a server 170 via a process data link 180. This simulation system 100 may include and/or be utilized with other tracking systems, in some embodiments. (E.g., because tracking system for weapons require a relatively high degree of accuracy, a separate tracking system may be used to track six degrees of freedom (6DOF) information for weapons used in a simulation provided by the simulation system 100.)

A person of ordinary skill in the art will appreciate various alternative embodiments to the embodiment illustrated in FIG. 1. Embodiments may have, for example, any number of cameras 110 and/or clients 160. In FIG. 1, the number of clients 160 matches the number of cameras, each camera 110 sending video data to a respective client 160. However, in other embodiments (where processing power of a client 160 permits, for example) a single client 160 may process data from a plurality of cameras. (Additionally or alternatively, a single camera may send video data to a plurality of clients 160.) It can also be noted that, although the server 170 and client(s) 160 are depicted as corresponding to physical computer systems, a person of ordinary skill in the art will appreciate that the server 170 and client(s) 160 may correspond to software applications executed by one or more computer systems, which may not correspond to or be arranged in the same manner as the computer systems depicted in FIG. 1. These software applications may be, for example, executed by hardware of a single physical system (e.g., a server rack), or a distributed network of computers.

The location and configuration of the simulation system 100 may also vary, depending on desired functionality. In FIG. 1, cameras 110 are located on a truss 120 suspended above the rectangular simulation floor 130. Positioning cameras 110 above the subjects 140 in this manner can help reduce the likelihood that one subject 140 will occlude another from the perspective of the cameras 110, increasing the amount of position and posture information of the subjects 140 gathered by the cameras 110. In alternative embodiments, however, the simulation floor 130 may be nonrectangular (and, thus, the associated simulation volume 135 may occupy a volume other than a rectangular cuboid, as shown), and/or cameras 110 may be located at various different heights and locations (which may accommodate a nonrectangular simulation floor 130). Moreover, embodiments of a simulation system 100 may be located in any environment, including indoor and outdoor spaces.

The number of cameras 110, as well as their positioning and arrangement, may vary depending on desired functionality. To help ensure accuracy in three dimensions, cameras 110 may be arranged so that, for any given point in the simulation space (i.e., the volume of space above the simulation floor 130 in which the subjects 140 may move during the simulation) in which subjects 140 can move during a simulation, three or more cameras 110 can capture video of an object (e.g., a subject 140) in that point. As such, smaller volumes may generally require fewer cameras, and larger volumes may generally require more cameras.

As previously noted, cameras 110 may comprise COTS cameras, including webcams and/or other charge-coupled device (CCD)-based cameras. For embodiments in which the room or other area in which the simulation floor 130 is located is illuminated with visible light, visible light cameras 110 may be used. In other embodiments, such as embodiments in which low-light conditions are used, other types of cameras may be used (e.g., infrared (IR) cameras).

Video data link 150 and processed data link 180 may comprise any of a variety of communication links, again depending on desired functionality. In some embodiments, for example, video data link 150 from cameras 110 to clients 160 and/or process to data link 180 may comprise a universal serial bus (USB), Ethernet, and/or a wireless communication link.

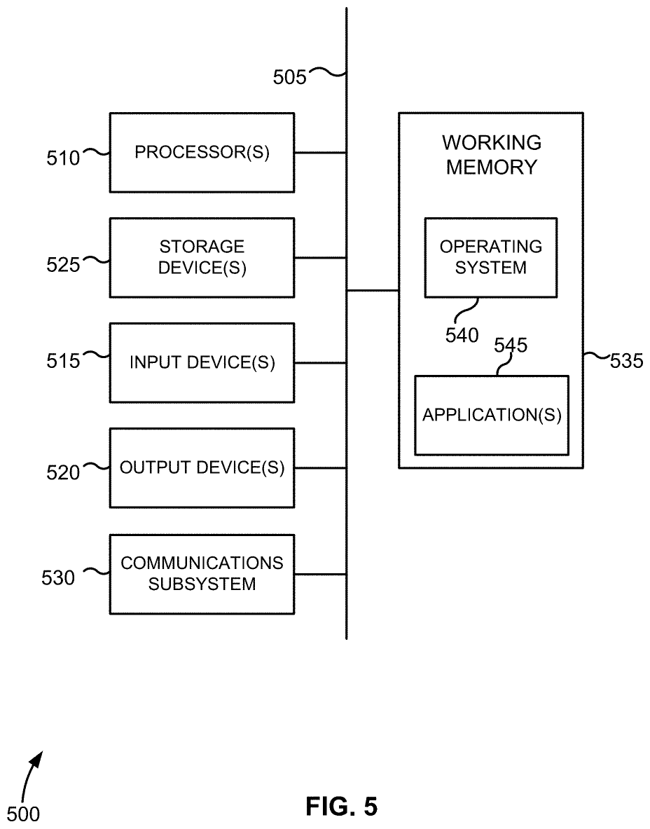

Operation of the simulation system 100 may proceed generally as follows. Cameras 110 capture video of subjects 140, and provide the video to the clients 160 via the video data link 150. Clients 160 (each comprising a computer system, as illustrated in FIG. 5, for example) can then process the video information using a 2D pose estimation software (such as OpenPose—which is a pose estimation software package currently owned and maintained by Carnegie Mellon University—or a variant thereof) to determine keypoint positions estimated in two dimensions for each subject 140 captured in the video data. Each camera 110 may capture multiple subjects 140. A client 160 may perform keypoint detection on multiple subjects 140 within the video data of the respective camera 110. Moreover, the client 160 may group together keypoints of different subjects 140, thereby making the keypoints of one subject 140 distinguishable from another. Because a camera 110 may capture only a portion of a subject 140, some groups of keypoints may be incomplete sets of keypoints. That is, the complete 2D skeleton for each subject 140 may not be captured by a single camera 110 in any given video frame.

The joint positions may vary, depending on functionality. Joint positions can include, for example, shoulders, hips, knees, ankles, elbows, and wrists. Right and left joints may be distinguishable, and thus, clients 160 may track full 6DOF movement of a human body skeleton, including head, torso, arms, and legs. The output of the clients 160 may provide these joint positions (e.g., location and rotation of each joint) to the server 170 at a certain rate (e.g., at 15 frames per second (fps) or more), which may be dependent on the processing abilities of the clients 160 and/or rate and size of video data received from cameras 110. In some embodiments, the output of the clients 160 may be synchronized, while other embodiments may have asynchronous output.

The server 170 (which may also comprise a computer system, as illustrated in FIG. 5, for example) can then perform a combination of 2D keypoints (2D skeletons) across all cameras 110 into a set of 3D skeletons for each camera frame. The server 170 may additionally synchronize captured images across all cameras (e.g., when the output from the clients 160 and/or cameras 110 might not be synchronized). The server 170 can then inject the 3D skeleton of each of the subjects 140 into a simulation game engine (e.g., CryEngine® or Unreal Engine®) such that the 3D skeleton of each subject 140 correctly manipulates a respective virtual avatar within the simulated environment. The subjects 140 may be able to see this simulated environment via head-mounted displays (HMDs) (not shown) in real-time. As such, the simulation system 100 can provide an immersive simulation environment for the subjects 140 in which subjects can move anywhere within the simulation volume 135, and their positions and postures can be determined and accurately reflected in a virtual visualization provided to the subjects 140, allowing subjects 140 to see avatars in a simulated environment accurately reflecting the position and posture of the other subjects 140 on the simulation floor 130 (i.e., the position and posture of the avatars in this simulated environment accurately reflecting the position and posture of the subjects 140 in the physical world).

The simulation system 100 may be used to create a larger simulation environment for training, depending on desired functionality. For example, multiple simulation systems 100, each having respective simulation volumes 135, may be used in a single simulated environment to conduct single live training, game, or other virtual event from multiple simulation systems 100. As such, the separate simulation systems 100 may be located in various geographically dispersed locations, but used to create a single immersive simulation environment showing all participating subjects 140. Additionally or alternatively, a visualization of the simulated environment (e.g., created by a simulation game engine) may not only be provided to subjects 140 in the simulation volume 135 in the one or more simulation systems 100, but the visualization may allow third parties (observers, trainers, etc.) to view the simulated environment as well. Depending on desired functionality, third parties may be able to change views of the simulated environment and/or replay the simulation after the live simulation has completed.

The accuracy of determining where the position and pose of the subjects 140 can vary, and may be customized to a particular application. Accuracy can be dependent on a variety of factors, such as resolution of the cameras 110, accuracy of and/or amount of data extracted from the calibration process (including accuracy of parameter estimates for spherical aberrations and/or other characteristics of the camera 110), and the like. In general, the more cameras 110, the more accurate the simulation system 100 will be. In an embodiment having a 100×30 foot simulation floor 130 and eight cameras 110, for example (similar to the embodiment illustrated in FIG. 1), accuracy of keypoints on a 3D skeleton of a subject 140 are found to be within a few centimeters of the actual location. Alternative embodiments may result in a different level of accuracy.

Because keypoint detection performed by clients 160 may be performed primarily by a graphics processing unit (GPU), it can be noted that a client 160 may additionally perform the functions of a server 170, in some embodiments, because the functionality of the server 170 may be performed by a central processing unit (CPU). As such, the hardware used to perform the functionality of the clients 160 may be different than the hardware used to perform the functionality of the server 170, and may therefore potentially be performed by the same computer system. Moreover, because a computer system may comprise a plurality of GPUs, a single computer system may correspondingly equivalently perform the functions of a plurality of clients 160. In some embodiments, a single computer system, if capable, may be used to perform the functions of the server 170 and all the clients 160 illustrated in FIG. 1 and described above.

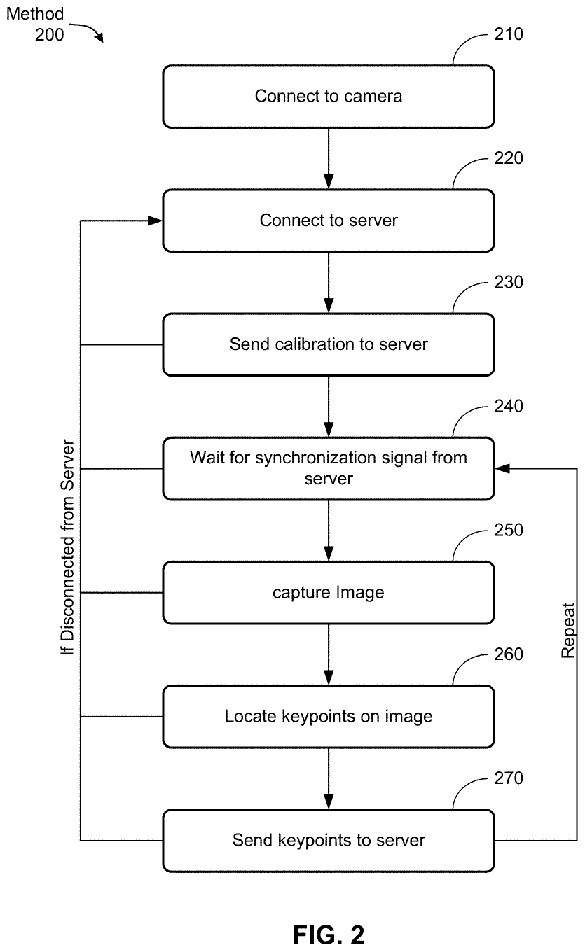

FIGS. 2-4 are flow diagrams illustrating algorithms executable by the clients 160 and server 170 to help facilitate the functionality described above. For each of these flow diagrams, it will be understood that alternative embodiments may exist where functions shown in the blocks of the flow diagrams are combined, separated, performed in alternative order, performed in parallel, or the like. A person of ordinary skill in the art will appreciate such variations.

FIG. 2, for example, illustrates a method 200 executed at a client 160 in order to provide the necessary keypoint information to the server 170, according to some embodiments. Here, as shown in FIG. 1, the client 160 is communicatively coupled with a corresponding camera 110 and the server 170. As previously noted, the client 160 may comprise a computer system (e.g., as illustrated in FIG. 5 and described in more detail below), and thus, the various functions shown in the blocks illustrated in FIG. 2 may be performed by hardware and/or software components of a computer system functioning as the client 160.

At block 210, the functionality comprises connecting to (i.e., establishing a communication channel with) a camera. As previously noted, the data connection between a camera 110 and a client 160 may comprise any of a variety of wired and/or wireless connections. As such, the process of connecting to the camera performed at block 210 may comprise a process governed by standards and/or protocols applicable to the connection type.

At block 220, the client 160 then connects to the server 170. Similar to connecting with a camera at block 210, the functionality at block 220 may comprise executing one or more algorithms in accordance with governing protocols and/or standards to establish a data connection with the server 170. This may further comprise enabling a client software application executed by the client 160 to communicate with the server software application executed by the server 170 via an Application Programming Interface (API) or other software interface.

To be able to create 3D skeletons from the 2D keypoint information provided by the clients 160, the server 170 uses the 6DOF information of each of the cameras 110. This information (also referred to herein as “calibration information”) can be gathered by the client 160 during a calibration process and provided to the server 170 as indicated at block 230 of FIG. 2. This calibration information may only need to be sent to the server when initially calibrated, when cameras 110 are moved or rotated (i.e., the 6DOF information changes), and/or when the client 160 is disconnected from the server 170 (as shown in FIG. 2).

The calibration process may vary, depending on desired functionality. In some embodiments, an object may be placed in the simulation space (e.g. somewhere on the simulation floor 130), where points on the object are at known locations (e.g., at known coordinates within an XYZ coordinate system) within the simulation space. From there, estimation algorithms (e.g., Structure from Motion (SfM) algorithms, Perspective-n-Point (PnP) algorithms, etc.) may be utilized to determine the location of each of the cameras 110 with respect to the object, based on images of the object taken by the cameras 110. (The calibration process may involve placing the object in multiple locations within the simulation space to ensure each camera 110 is able to capture images of the object during the calibration.) Calibration results in the determination of the 6DOF information for each of the cameras 110 with respect to a common frame of reference, which may then be used when tracking the location of subjects 140 within the simulation space.

According to some embodiments, image capture may be synchronized among the clients 160, to help ensure accuracy in locating keypoints of the subjects 140 accurately. Thus, according to some embodiments, the server 170 can provide a signal or command to the clients 160 to capture a frame. Accordingly, at block 240, the client 160 can wait for a synchronization signal from the server 170. As a person of ordinary skill in the art will appreciate, the synchronization signal may be provided in any of a variety of forms, such an API command, a specialized signal or packet of information, or the like.

Once signal is received, the method 200 then proceeds to block 250, where the client 160 causes the corresponding camera 110 to capture an image. The client 160 can then process the image to locate keypoints on the image, as shown in block 260, and send the keypoint information for the image to the server 170, as shown in block 270. As previously noted, this keypoint information may comprise a 2D skeleton (a set of 2D keypoints, which may be provided in the XY coordinates of the image) of one or more subjects 140 in the simulation volume 135, captured in the image. The server 170 can then use the keypoint information from multiple cameras to calculate a location of each of the keypoints in the 3D space of the simulation volume 135. After the keypoints are sent to the server 170 at block 270, the client can then return to block 240, waiting for a synchronization signal from the server. This process can repeat multiple times per second (e.g., at 15 fps or more), allowing the simulation system 100 to perform tracking of the one or more subjects 140 in real-time (or near-real-time) from video obtained by the cameras 110.

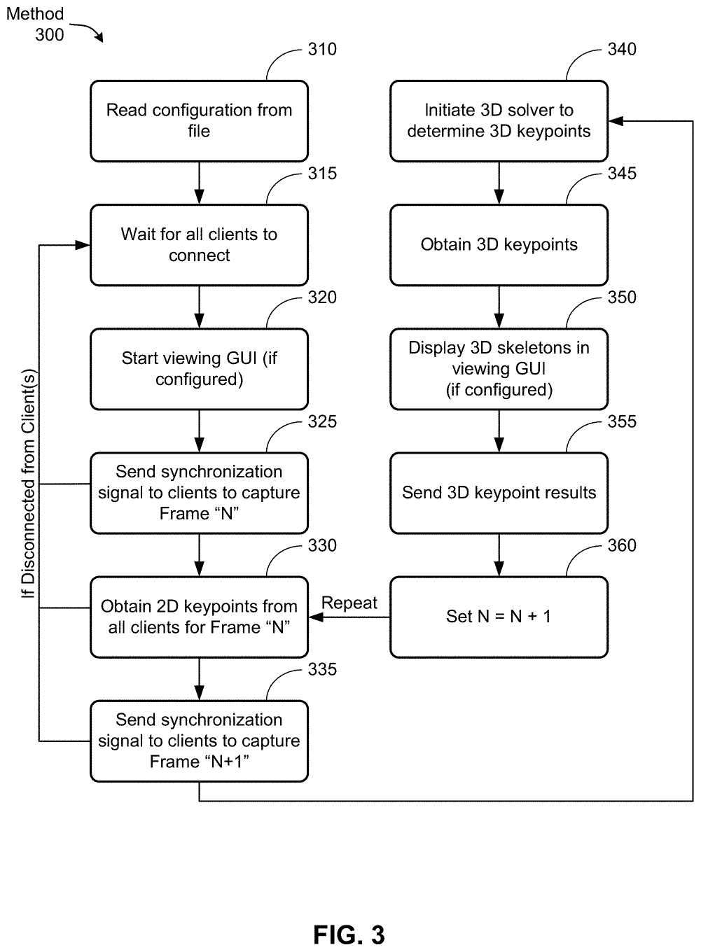

FIG. 3 is a flow diagram illustrating a method 300 that the server 170 can perform, according to an embodiment. As illustrated in FIG. 1, the server 170 is communicatively coupled with one or more clients 160 of the simulation system 100. Similar to the clients 160, the server 170 may comprise a computer system (e.g., as illustrated in FIG. 5 and described in more detail below), and thus, the various functions shown in the blocks illustrated in FIG. 2 may be performed by hardware and/or software components of a computer system functioning as the server 170.

Here, the server can begin the method 300 at block 310, by reading a configuration file. The configuration file may specify the number of clients 160 that will be connecting to the server 170, the location of the calibration file for each camera in the simulation space (which can allow the server 170 to accurately perform the 3D determination of keypoints, based on 2D keypoint information for an image obtained from a camera, and configuration information for the camera. The configuration file may also specify the location of the type of pose model the simulation system 100 will be running. (A pose model can define what keypoints the 2D algorithm will be returning to the system, and may be configurable via the configuration file.)

At block 315, the server 170 can then wait for the clients 160 to connect. Once all clients 160 are connected, the server 170 can then start the graphical user interface (GUI) that may be viewed from an operator as shown at block 320.

As noted above with regard to FIG. 2, the server 170 can send a synchronization signal/command to clients, to help ensure images taken by the cameras 110 of the simulation system 100 are taken at substantially the same time. Accordingly, at block 325, the method 300 includes the server 170 sending a synchronization signal to clients 160 to capture a set of images (one image per camera; collectively “Frame N”). As previously discussed with regard to FIG. 2 (e.g., at blocks 240-270), each client 160 can cause a corresponding camera 110 to capture an image, locate the 2D keypoints of one or more subjects 140 in the image, and return the 2D keypoints in the image to the server 170. At block 330, the server obtains, 2D keypoints from all the clients for the image set (Frame N). The server 170 can then, at block 335, send another synchronization signal to the clients to capture the next set of images (“Frame N+1”).

As the clients capture the next set of images, the server 170 can implement the functionality at block 340, in which uses a “solver” algorithm to determine where, within the space of the simulation volume 135, each the keypoints are located for each of the one or more subjects 140. In other words, the solver algorithm uses the 2D keypoints received from the clients 160 combined with the estimated orientation and position (6DOF) of each camera (obtained through the calibration process) to create a 3D skeleton (a set of 3D keypoints), for each of the subjects 140 in the video data of the cameras 110. After doing so, the 3D skeletons may be provided to a gaming engine which can, at block 350, display the 3D skeletons, and/or corresponding avatars, in the viewing GUI. Additionally or alternatively, at block 355, 3D keypoint results may be sent to any other interested listeners. Here, “listeners” may comprise other systems that can utilize the skeleton information provided by the server 170 for visualization, analytics, and/or other purposes. Finally, at block 360, the server can repeat the process by setting N=N+1, and returning to the functionality at block 330.

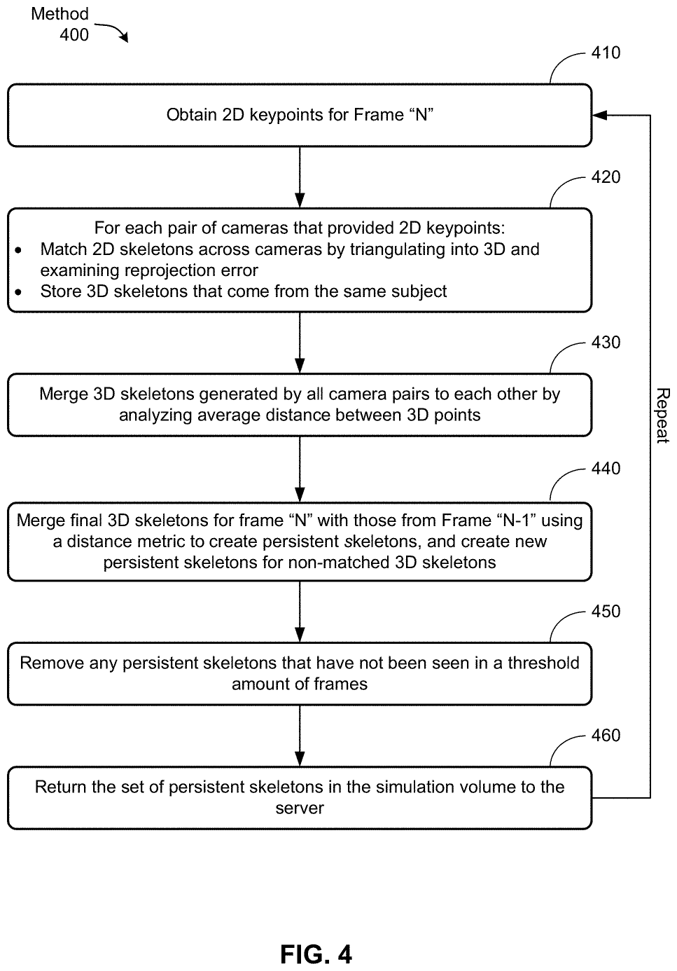

FIG. 4 illustrates a method 400 that may be used by the solver algorithm of the server 170 to combine the 2D keypoints extracted from the video data of the cameras 110 and provided by the clients 160 into a 3D skeleton for each of the subjects 140, according to an embodiment. Of course, alternative embodiments may utilize a different type of solver algorithm, depending on desired functionality. The server 170 may use software and/or hardware components to perform any or all of the functions illustrated in the blocks of FIG. 4. Additionally or alternatively, software and/or hardware components of another computer system (communicatively coupled with the server) may perform one or more functions of method 400, providing the result to the server 170. As with other figures provided herein, a person of ordinary skill in the art will appreciate how alternative embodiments may rearrange or otherwise alter the functions illustrated in FIG. 4. As noted above and illustrated in FIG. 3, this method 400 may be performed on-the-fly, as frames are captured by the cameras 110 and corresponding 2D keypoints are provided by the clients 160 to the server 170.

In this embodiment, the method 400 can begin at block 410, where 2D keypoints are obtained for a given set of images (frame “N”). At block 420, the functionality includes, for each pair of cameras for which 2D keypoints are provided, matching groups of keypoints (2D skeletons) between pairs of cameras 110 for all subjects 140 in the images of the pair of cameras 110 so that 2D skeletons for all subjects 140 in an image from a first camera are all compared against 2D skeletons for all subjects 140 in an image from a second camera. For each comparison, 2D skeletons are triangulated into a 3D space to create a 3D skeleton, and a reprojection error is examined. If a reprojection error is above a certain threshold, it can be disregarded (presumably indicative of the 2D skeletons coming from different subjects 140). If it is below a certain threshold, it can then be compared with reprojection errors from comparisons of 2D skeletons between images of other pairs of cameras 110. This can be done for all pairs of cameras 110. This can result in each subject 140 having a 3D skeleton generated from data for each pair of cameras 110.

At block 430, the 3D skeletons from all camera pairs for a subject 140 can be merged into a final 3D skeleton for the subject by averaging the matching triangulated 3D keypoints across all camera pairs. That said, different embodiments may utilize optimizations (e.g., based on camera location) so that image comparisons of a subset of all images captured at a given time (e.g. “Frame N” in FIG. 4) are compared. This can be repeated for all subjects 140 in the simulation system 100, resulting in a unique 3D skeleton for each subject 140.

At block 440, 3D skeletons of a current frame (“Frame N”) may be merged with corresponding skeletons of a previous frame (“Frame N−1”) to allow continuous identification (tracking) of an individual. The matching of 3D skeletons across frames can be done using a distance metric to identify the 3D skeleton in the previous frame closest to a 3D skeleton in the current frame. (This distance metric may be, for example, the same or similar to the distance metric used for matching skeletons across camera pairs.) These 3D skeletons tracked across multiple frames are known as “persistent” skeletons (as noted in FIG. 4). That said, new 3D skeletons for non-matched 3-D skeletons in the current frame may be counted among the persistent skeletons, and, as noted in block 450, previous persistent skeletons that have not been matched for a threshold amount of frames can be removed from the list of identified persistent skeletons.

Finally, at block 460, the set of persistent skeletons identified in the simulation volume 135 can then be passed to the server 170, which can then display the resulting 3D skeletons as indicated in FIG. 3 (at block 350). In alternative embodiments, alternative algorithms for thresholding and/or best match identification may be utilized.

The use of the output 3D skeleton in a simulation game engine may require converting the format of the 3D skeletons to an acceptable format for a simulation game engine to render an avatar in the visualization. Inverse kinematic algorithms may be utilized to map the 3D skeleton to a rigid body skeleton (using, for example, a point-and-rotation model). Additional or alternative means for mapping may be utilized, depending on the information and formatting of the 3D skeleton and required inputs for the simulation game engine.

FIG. 5 shows a simplified computer system 500, according to some embodiments of the present disclosure. A computer system 500 as illustrated in FIG. 5 may, for example, function as and/or be incorporated into a server 170, client 160, HMD, and/or other device as described herein. FIG. 5 provides a schematic illustration of one embodiment of a computer system 500 that can perform some or all of the steps of the methods provided by various embodiments. It should be noted that FIG. 5 is meant only to provide a generalized illustration of various components, any or all of which may be utilized as appropriate. FIG. 5, therefore, broadly illustrates how individual system elements may be implemented in a relatively separated or relatively more integrated manner.

The computer system 500 is shown comprising hardware elements that can be electrically coupled via a bus 505, or may otherwise be in communication, as appropriate. The hardware elements may include one or more processors 510, including without limitation one or more general-purpose processors (e.g., CPUs) and/or one or more special-purpose processors such as digital signal processing chips, graphics acceleration processors (e.g., GPUs), and/or the like; one or more input devices 515, which can include without limitation a mouse, a keyboard, a camera, and/or the like; and one or more output devices 520, which can include without limitation a display device, a printer, and/or the like.

The computer system 500 may further include and/or be in communication with one or more non-transitory storage devices 525, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 500 might also include a communication interface 530, which can include without limitation a modem, a network card (wireless or wired), an infrared communication device, a wireless communication device, and/or a chipset, and/or the like. The communication interface 530 may include one or more input and/or output communication interfaces to permit data to be exchanged (e.g., via video data link 150 and/or processed data link 180) with other computer systems, cameras, HMDs, and/or any other devices described herein.

The computer system 500 also can include software elements, shown as being currently located within the working memory 535, including an operating system 540, device drivers, executable libraries, and/or other code, such as one or more application programs 545, which may comprise computer programs provided by various embodiments, and/or may be designed to implement methods, and/or configure systems, provided by other embodiments, as described herein. Merely by way of example, all or part of one or more procedures described with respect to the methods discussed above, and/or methods described in the claims, might be implemented as code and/or instructions executable by a computer and/or a processor within a computer. In an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 525 described above. In some cases, the storage medium might be incorporated within a computer system, such as computer system 500. In other embodiments, the storage medium might be separate from a computer system e.g., a removable medium, such as a compact disc, and/or provided in an installation package, such that the storage medium can be used to program, configure, and/or adapt a general purpose computer with the instructions/code stored thereon. These instructions might take the form of executable code, which is executable by the computer system 500 and/or might take the form of source and/or installable code, which, upon compilation and/or installation on the computer system 500 e.g., using any of a variety of generally available compilers, installation programs, compression/decompression utilities, etc., then takes the form of executable code.

It will be apparent to those skilled in the art that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 500 to perform methods in accordance with various embodiments of the technology. According to a set of embodiments, some or all of the procedures of such methods are performed by the computer system 500 in response to processor(s) 510 executing one or more sequences of one or more instructions, which might be incorporated into the operating system 540 and/or other code, such as an application program 545, contained in the working memory 535. Such instructions may be read into the working memory 535 from another computer-readable medium, such as one or more of the storage device(s) 525. Merely by way of example, execution of the sequences of instructions contained in the working memory 535 might cause the processor(s) 510 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 500, various computer-readable media might be involved in providing instructions/code to processor(s) 510 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 525. Volatile media include, without limitation, dynamic memory, such as the working memory 535.

Various forms of computer-readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 500.

The communication interface 530 and/or components thereof generally will receive signals, and the bus 505 then might carry the signals and/or the data, instructions, etc. carried by the signals to the working memory 535, from which the processor(s) 510 retrieves and executes the instructions. The instructions received by the working memory 535 may optionally be stored on a non-transitory storage device 525 either before or after execution by the processor(s) 510.

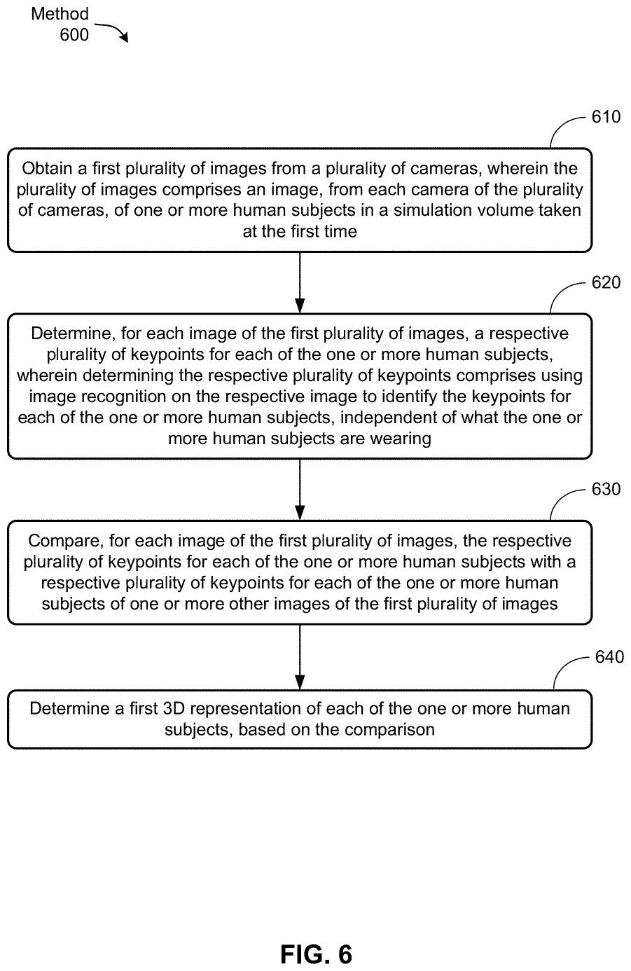

FIG. 6 is a block diagram of a method 600 for tracking human movement, according to an embodiment. Here, the functions provided in each of the blocks of FIG. 6 may be performed by one or more of the components of the simulation system 100, such as the client(s) 160 and/or server 170. Moreover, because the client(s) 160 and server 170 may comprise a computer system, means for performing the functions illustrated in each of the blocks of FIG. 6 may comprise software and/or hardware components of a computer system, such as those illustrated in FIG. 5 and described above. As with other figures provided herein, FIG. 6 is provided as an example embodiment, and alternative embodiments may employ any number of variations, such as performing functions in different order, combining functions, separating functions, etc.

At block 610, the functionality comprises obtaining a first plurality of images from a plurality of cameras, where the plurality of images comprises an image, from each camera of the plurality of cameras, of one or more human subjects in a simulation volume taken at a first, and time. As previously noted, this first plurality of images may comprise a first “frame,” and a server may send a synchronization instruction (e.g., a signal, command, message, etc.) to one or more clients to cause the plurality of cameras capture the first frame at substantially the same time.

The functionality at block 620 comprises determining, for each image of the first plurality of images, a respective plurality of keypoints for each of the one or more human subjects. Determining the respective plurality of keypoints comprises using image recognition on the respective image to identify the keypoints for each of the one or more human subjects, independent of one the one or more human subjects are wearing. As previously noted, a 2-D pose-estimation software, such as OpenPose, can be used to determine keypoints of human subjects within an image. Because such pose-estimation software can operate on image recognition of human subjects, keypoints can be determined without the need of using special markers, equipment, etc. As such, unlike other image capture techniques, embodiments provided herein can allow human subjects to participate in simulations without the need to wear any special gear. Pose estimation based on image recognition of human subjects can be independent of what the human subjects are wearing.

At block 630, the method 600 comprises comparing, for each image of the first plurality of images, the respective plurality of keypoints for each of the one or more human subjects with a respective plurality of keypoints for each of the one or more human subjects of one or more other images of the first plurality of images. As previously stated, such comparisons may comprise determining a 3D keypoints from 2D keypoints in pairs of images. Thus, according to some embodiments, the comparing functionality at block 630 may, at least in part, comprise triangulating, using a first pair of images of the first plurality of images, each keypoint in the first plurality of keypoints for the first human subject of one or more human subjects to determine a corresponding first plurality of 3D keypoints.

Further, as noted in FIG. 4, these different 3D keypoints for a particular human subject can be merged to create a final set of 3D keypoints for the subject. Thus, according to some embodiments, the method 600 may further comprise determining a final plurality of 3D keypoints for the first human subject at least in part by determining, for each keypoint of the first plurality of 3D keypoints, a distance between the respective keypoint of the first plurality of 3D keypoints and a corresponding keypoint of a second plurality of 3D keypoints of the first human subject, where the second plurality of 3D keypoints is determined from a second pair of images of the first plurality of images.

At block 640, the functionality comprises determining a first 3D representation of each of the one or more human subjects, based on the comparison. As noted in the embodiments provided herein, this 3D representation of each of the one or more human subjects may comprise a final plurality of 3D keypoints (e.g., a final 3D skeleton) for each of the human subjects. Furthermore, this 3D representation may be used to create an avatar or other representation of the subject within a visualization of the simulated environment, which can be provided to subjects and/or others. Thus, according to some embodiments, the method 600 may further comprise generating a visualization based on the determined first 3D representation of each of the one or more human subjects. In some embodiments, this visualization may be provided to one or more HMDs worn by the one or more human subjects.

As noted in the embodiments above, embodiments may further correlate these 3D keypoints for a subject between frames, allowing for tracking of the subject over time. Thus, according to some embodiments, the method 600 may further comprise causing each camera to capture, at a second time, a respective image of the one or more human subjects in the simulation volume, resulting in the respective second plurality of images of the one or more human subjects in the simulation volume taken at a second time, determining a second 3D representation of at least one human subject of the one or more human subjects, and correlating the second 3D representation of the at least one human subject to the first 3D representation of the least one human subject. Similar to matching 3D keypoints between different pairs of images to determine the 3D keypoints belong to a single subject, the matching of 3D keypoints between frames can be distance based. Thus, according to some embodiments, the method may further comprise correlating the second 3D representation of the at least one human subject to the first 3D representation of the at least one human subject at least in part by, for each 3D keypoint of the second 3D representation, determining a distance between the respective 3D keypoint of the second 3D representation with the corresponding 3D keypoint of the first 3D representation of the at least one human subject.

As noted with regard to FIG. 1, the functionality of determining a 2D keypoints from images may be performed by different hardware and/or software components than those performing the functionality of determining the 3D keypoints. As such, according to some embodiments, the functionality at block 620 of determining the respective plurality of keypoints for each of the one or more human subjects may be executed by a first computer system, and the functionality at block 640 of determining the 3D representation of the one or more human subjects may be executed by a second computer system. Moreover calibration and/or synchronization information may be communicated between the two computer systems. Thus, according to some embodiments, the first computer system may send calibration information regarding at least one camera of the plurality of cameras to the second computer system, where the calibration information comprises information indicative of the location and orientation (e.g., 6DOF) of each camera of the plurality of cameras. Additionally or alternatively, according to some embodiments, the second computer system may send a synchronization instruction to the first computer system, instructing the first computer system to obtain, using a camera of the plurality of cameras, the respective image of the one or more human subjects in a simulation volume of the first time.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a user” includes a plurality of such users, and reference to “the processor” includes reference to one or more processors and equivalents thereof known to those skilled in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups. As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

What is claimed is:

1. A system for tracking human movement comprising:
a plurality of cameras, wherein each camera is configured to capture, at a first time, a respective image of one or more human subjects in a simulation volume, resulting in a respective first plurality of images of the one or more human subjects in the simulation volume taken at the first time;
one or more computer systems communicatively coupled with the plurality of cameras and configured to:
determine, for each image of the first plurality of images, a respective plurality of keypoints for each of the one or more human subjects, wherein determining the respective plurality of keypoints comprises using image recognition on the respective image to identify the keypoints for each of the one or more human subjects, independent of what the one or more human subjects are wearing;
compare, for each image of the first plurality of images, the respective plurality of keypoints for each of the one or more human subjects with a respective plurality of keypoints for each of the one or more human subjects of one or more other images of the first plurality of images; and
determine a first 3D representation of each of the one or more human subjects, based on the comparison.

2. The system for tracking human movement of claim 1, wherein the one or more computer systems are further configured to generate a visualization based on the determined first 3D representation of each of the one or more human subjects.

3. The system for tracking human movement of claim 2, further comprising one or more head-mounted displays (HMDs) configured to be worn by the one or more human subjects and to display the visualization.

4. The system for tracking human movement of claim 1, wherein the determining the respective plurality of keypoints for each of the one or more human subjects is executed by a first computer system of the one or more computer systems, and the determining the 3D representation of the one or more human subjects is executed by a second computer system of the one or more computer systems.

5. The system for tracking human movement of claim 4, wherein: the first computer system is further configured to send calibration information regarding at least one camera of the plurality of cameras to the second computer system, the calibration information comprising information indicative of a location and orientation of each camera of the plurality of cameras.

6. The system for tracking human movement of claim 4, wherein the second computer system is further configured to send a 2-D pose estimation software synchronization instruction to the first computer system, instructing the first computer system to obtain, using a camera of the plurality of cameras, the respective image of the one or more human subjects in a simulation volume at the first time.

7. The system for tracking human movement of claim 1, wherein the one or more computer systems are configured to compare, for each image of the first plurality of images, the respective plurality of keypoints for each of the one or more human subjects with a respective plurality of keypoints for each of the one or more human subjects of the one or more other images of the first plurality of images, at least in part by:
using a first pair of images of the first plurality of images, triangulating each keypoint in a first plurality of keypoints for a first human subject of the one or more human subjects to determine a corresponding first plurality of 3D keypoints.

8. The system for tracking human movement of claim 7, wherein the one or more computer systems are further configured to determine a final plurality of 3D keypoints for the first human subject at least in part by determining, for each keypoint of the first plurality of 3D keypoints, a distance between the respective keypoint of the first plurality of 3D keypoints and a corresponding keypoint of a second plurality of 3D keypoints of the first human subject, the second plurality of 3D keypoints being determined from a second pair of images of the first plurality of images.

9. The system for tracking human movement of claim 1, wherein:
each camera is configured to capture, at a second time, a respective image of the one or more human subjects in the simulation volume, resulting in a respective second plurality of images of the one or more human subjects in the simulation volume taken at the second time; and
the one or more computer systems are further configured to:
determine a second 3D representation of at least one human subject of the one or more human subjects; and
correlate the second 3D representation of the at least one human subject to the first 3D representation of the at least human subject.

10. The system for tracking human movement of claim 9, wherein the one or more computer systems are configured to correlate the second 3D representation of the at least one human subject to the first 3D representation of the at least one human subject at least in part by, for each 3D keypoint of the second 3D representation, determining a distance between the respective 3D keypoint of the second 3D representation with a corresponding 3D keypoint of the first 3D representation of the at least one human subject.

11. A method of tracking human movement comprising:
obtaining, at a first time, from each camera of a plurality of cameras, a respective image of one or more human subjects in a simulation volume, resulting in a respective first plurality of images of the one or more human subjects in the simulation volume taken at the first time;
determining, for each image of the first plurality of images, a respective plurality of keypoints for each of the one or more human subjects, wherein determining the respective plurality of keypoints comprises using image recognition on the respective image to identify the keypoints for each of the one or more human subjects, independent of what the one or more human subjects are wearing;
comparing, for each image of the first plurality of images, the respective plurality of keypoints for each of the one or more human subjects with a respective plurality of keypoints for each of the one or more human subjects of one or more other images of the first plurality of images; and
determining a first 3D representation of each of the one or more human subjects, based on the comparison.

12. The method of claim 11, further comprising generating a visualization based on the determined first 3D representation of each of the one or more human subjects.

13. The method of claim 12, further comprising causing one or more head-mounted displays (HMDs) worn by the one or more human subjects to display the visualization.

14. The method of claim 11, wherein the determining the respective plurality of keypoints for each of the one or more human subjects is executed by a first computer system, and the determining the 3D representation of the one or more human subjects is executed by a second computer system.

15. The method of claim 14, further comprising sending calibration information regarding at least one camera of the plurality of cameras from the first computer system to the second computer system, the calibration information comprising information indicative of a location and orientation of each camera of the plurality of cameras.

16. The method of claim 14, further comprising sending a 2-D pose estimation software synchronization instruction from the second computer system to the first computer system, instructing the first computer system to obtain, using a camera of the plurality of cameras, the respective image of the one or more human subjects in a simulation volume at the first time.

17. The method of claim 11, further comprising comparing, for each image of the first plurality of images, the respective plurality of keypoints for each of the one or more human subjects with a respective plurality of keypoints for each of the one or more human subjects of the one or more other images of the first plurality of images, at least in part by:
using a first pair of images of the first plurality of images, triangulating each keypoint in a first plurality of keypoints for a first human subject of the one or more human subjects to determine a corresponding first plurality of 3D keypoints.

18. The method of claim 17, further comprising determining a final plurality of 3D keypoints for the first human subject at least in part by determining, for each keypoint of the first plurality of 3D keypoints, a distance between the respective keypoint of the first plurality of 3D keypoints and a corresponding keypoint of a second plurality of 3D keypoints of the first human subject, the second plurality of 3D keypoints being determined from a second pair of images of the first plurality of images.

19. The method of claim 11, further comprising:
obtaining, at a second time, from each camera of the plurality of cameras, a respective image of the one or more human subjects in the simulation volume, resulting in a respective second plurality of images of the one or more human subjects in the simulation volume taken at the second time;
determining a second 3D representation of at least one human subject of the one or more human subjects; and
correlating the second 3D representation of the at least one human subject to the first 3D representation of the at least human subject.

20. A non-transitory computer-readable medium having instructions stored therewith for tracking human movement, wherein the instructions, when executed by one or more processing units, cause the one or more processing units to:
obtain, at a first time, from each camera of a plurality of cameras, a respective image of one or more human subjects in a simulation volume, resulting in a respective first plurality of images of the one or more human subjects in the simulation volume taken at the first time;
determine, for each image of the first plurality of images, a respective plurality of keypoints for each of the one or more human subjects, wherein determining the respective plurality of keypoints comprises using image recognition on the respective image to identify the keypoints for each of the one or more human subjects, independent of what the one or more human subjects are wearing;
compare, for each image of the first plurality of images, the respective plurality of keypoints for each of the one or more human subjects with a respective plurality of keypoints for each of the one or more human subjects of one or more other images of the first plurality of images; and
determine a first 3D representation of each of the one or more human subjects, based on the comparison.
